(19) United States
(12) Patent Application Publication
(10) Pub. No.: US 2023/0197941 A1
(43) Pub. Date: Jun. 22, 2023

(54) SI-COMPOSITE MATERIALS FOR USE IN LITHIUM-ION BATTERY ANODES AND METHODS OF MAKING THE SAME

(71) Applicant: NOHMS Technologies, Inc., Rochester, NY (US)

(72) Inventors: Surya S. Moganty, Henrietta, NY (US); Rutvik Vaidya, Rochester, NY (US); Xiaojing Zhu, Rochester, NY (US); Kevin R. Brown, JR., Rochester, NY (US)

(21) Appl. No.: 18/083,085

(22) Filed: Dec. 16, 2022

Related U.S. Application Data
(60) Provisional application No. 63/290,273, filed on Dec. 16, 2021.

(51) Int. Cl. H01M 4/48; H01M 4/62; H01M 4/04

(52) U.S. Cl. CPC H01M 4/48; H01M 4/625; H01M 4/622; H01M 4/0404; H01M 2004/021

(57) ABSTRACT

An anode formulation containing a plurality of active Si-composite material particles, a plurality of conductive carbon particles and at least one polymer binder that undergoes a cyclization reaction when heated; an anode formed from the anode formulation; a method of making the anode; and an electrochemical energy storage device including the anode, a cathode and an electrolyte including fluorinated carbonate are disclosed.

### CROSS REFERENCE

This application claims the benefit of the filing date of U.S. Provisional Patent Application No. 63/290,273, filed Dec. 16, 2021, which is hereby incorporated by reference in its entirety.

### FIELD

The present disclosure relates to Silicon (Si)-based anodes for improving conductivity, specific capacity, and cycle life stability, and methods for producing high-capacity Si-based anodes suitable for use in electrochemical energy storage devices. More specifically, the present disclosure relates to the use of Si-composite materials, such as silicon-carbon composite materials, silicon oxides, and the like, as active material particles in a Li-ion battery anode.

### BACKGROUND

Lithium ion (Li-ion) batteries are heavily used in consumer electronics, electric vehicles (EVs), energy storage systems (ESS) and smart grids. The energy density of Li-ion batteries is dependent at least in part on the anode and cathode materials used. Optimizing processing and manufacturing of Li-ion batteries has allowed for a 4-5% improvement in the energy density of Li-ion batteries each year, but these incremental improvements are not sufficient for reaching energy density targets of next-generation technologies. To reach such targets, advancements in electrode materials will be required, such as incorporating high energy-density active materials into electrodes. Recent research has focused primarily on developing high energy cathodes, with only limited research dedicated to the development of anode materials.

Recently, silicon has emerged as one of the most attractive high energy anode materials for Li-ion batteries. Silicon's low working voltage and high theoretical specific capacity of 3579 mAh/g is nearly ten times that of conventional graphite, thus resulting in increased interest. U.S. Pat. Nos. 10,573,884 and 10,707,481 describe anode compositions including silicon active material particles and a polymer binder such as polyacrylonitrile (PAN). The silicon active material particles described in the '884 and '481 patents are pure silicon particles having a size in the nano to micron range. Also, an ionic liquid-based electrolyte was required.

One issue faced by anode materials including pure silicon as an active material is material level instability of the pure silicon. For example, when pure silicon is used as an active material for anodes, the pure silicon comes into direct contact with and is exposed to the electrolyte used therewith. This may result in anode and battery instability. Accordingly, a need exists for improved Si-based anode materials for Li-ion batteries.

### SUMMARY

In accordance with one aspect of the present disclosure, there is provided an anode formulation for forming an anode for use in an electrochemical energy storage device, the anode formulation including: a plurality of active Si-composite material particles, a plurality of conductive carbon particles; and at least one polymer binder that undergoes a cyclization reaction when heated.

In accordance with another aspect of the present disclosure, there is provided an anode for use in an electrochemical energy storage device, the anode including a current collector having a coating including an active Si-composite material, conductive carbon, and at least one cyclized polymer binder.

In accordance with another aspect of the present disclosure, there is provided an electrochemical energy storage device including an anode including a current collector having a coating including an active Si-composite material, conductive carbon, and at least one cyclized polymer binder; a cathode; and an electrolyte including fluorinated carbonate.

In accordance with another aspect of the present disclosure, there is provided a method of making an anode for use in an electrochemical energy storage device, the method including:
a) mixing together active Si-composite particles, conductive carbon particles and at least one polymer binder that undergoes a cyclization reaction when heated, to form a mixture;
b) coating the mixture onto a current collector to form a coated current collector; and
c) subjecting the coated current collector to a temperature treatment cyclizing the at least one polymer binder.

These and other aspects of the technology described herein will be apparent after consideration of the detailed description and the claims appended thereto.

### BRIEF DESCRIPTION OF THE DRAWINGS

FIG. 1 is a flow diagram illustrating a method of making an anode including Si-composite particles according to various embodiments described herein;

FIG. 2A is a picture showing an anode electrode prepared with polyvinylidene fluoride (PVDF) binder from the full pouch cell, after completion lithiation substantial expansion was observed and delamination of coating and FIG. 2B is a picture showing substantial expansion after complete lithiation; and

FIG. 3A is a picture showing an anode electrode prepared with cyclized PAN binder from the full pouch cell, even after completion lithiation, delamination of anode coating was not observed and FIG. 3B is a picture showing an anode electrode prepared with cyclized PAN binder from the full pouch cell, even after completion lithiation, delamination of anode coating was not observed due to cyclized PAN binder, which acts like a super glue providing excellent structural stability.

### DETAILED DESCRIPTION

Embodiments are described more fully below with reference to the accompanying figures, which forms a part hereof and shows, by way of illustration, specific exemplary embodiments. These embodiments are disclosed in sufficient detail to enable those skilled in the art to practice the disclosure. However, embodiments may be implemented in many different forms and should not be construed as being limited to the embodiments set forth herein. The following detailed description is, therefore, not to be taken in a limiting sense.

Described herein are various embodiments of Si-based anodes and methods of making the same, wherein the Si-based anodes include Si-composite materials as an active material component.

In some embodiments, an anode formulation configured for forming an anode for use in an electrochemical energy storage device is described. The anode formulation includes a plurality of active material particles, a plurality of conductive carbon particles, and at least one polymer binder that undergoes a cyclization reaction when heated. The active material particles include Si-composite particles, such as particles of Si-carbon composites or silicon oxide composites.

In some embodiments, an electrochemical energy storage device is described, the electrochemical energy storage device including an anode, a cathode and an electrolyte. The anode is made from a plurality of active material particles, conductive carbon particles, and at least one polymer binder that undergoes a cyclization reaction when heated. The active material particles include Si-composite particles, such as particles of Si-carbon composites or silicon oxide composites. The electrolyte can include fluorinated carbonate.

Described herein are various embodiments of a Si-based anode including Si-composite active materials. The use of Si-composite materials, such as Si-carbon and Si-oxide composites, as the active material in an anode material provides desired material level stability as compared to anode materials using pure Si as the active material. In embodiments where the Si-composite material provides a core-shell structure (e.g., Si core with carbon or oxide shell), the outer shell material shields the Si particles from direct contact and exposure to the electrolyte. The use of Si-composite material, such as those having a core-shell structure, also allows for silicon expansion and contraction in the core shell structure, based on the porosity of the outer shell. This results in improved stability of Si-based composite materials compared to pure Si active material.

The anode material formulation described herein includes a plurality of active material particles. At least some of the active material particles provided in the anode material are Si-composite particles. In some embodiments, all of the active material particles are Si-composite particles. When all active material particles present in the anode are Si-composite particles, the Si-composite particles may all be of the same type (e.g., all Si-composite particles are Si-carbon particles), or the Si-composite particles may be made up of two or more different types of Si-composite particles (e.g., some Si-composite particles are Si-carbon particles while other Si-composite particles are silicon oxide particles). In embodiments where the plurality of active material particles includes both Si-composite particles and non-Si-composite particles, the Si-composite particles can be all of one type or can be two or more types of Si-composite particles. The non-Si-composite particles may be any suitable type or types of active material that is not an Si-composite material. In some embodiments, the non-Si-composite particles included in the anode material are pure silicon particles.

Any suitable Si-composite material can be used for the Si-composite particles included in the anode material described herein. In some embodiments, the Si-composite particles are Si-carbon composite materials, such as carbon coated Si particles. In some embodiments, silicon oxides (SiOₓ) are used. The Si-composite can also be an alloy of Si with inert metals or non-metals. Other examples of Si-composite materials suitable for use in the embodiments described herein are graphene-silicon composites, graphene oxide-silicon-carbon nanotubes, silicon-polypyroles, and composites of nano and micron sized silicon particles. As described previously, any combination of Si-composite materials can be used in the anode material, or just a single Si-composite material can be used.

In some embodiments, the Si-composite material has generally a core-shell type structure, wherein the core is predominantly or exclusively silicon. The shell may be generally a non-silicon material that serves as a protective coating around the core of silicon material. For example, the Si-composite material may be a Si-carbon material having a core-shell structure such that the carbon forms a shell around the core of silicon material. For example, in the Si-carbon composite example described previously, the core may include some carbon in addition to the predominantly silicon core, and the shell may include some silicon in addition to the predominantly carbon shell.

In some embodiments, the Si-composite particle content of the anode material is from about 10 wt. % to about 90 wt. % of the anode material, such as about 20 wt. % to about 80 wt. % or about 50 wt. % to about 80 wt. %. In some embodiments, the Si-composite particles present in the anode composite material can have a size in the range of from about 1 nm to about 100 μm.

The anode material formulation described herein includes at least one polymer binder that undergoes a cyclization reaction when heated. The polymer component of the anode material typically serves as a binder material and provides conductivity to the anode material. In some embodiments, the at least one polymer is polyacrylonitrile (PAN). Other polymer materials in addition to PAN may also be included in the anode material as needed. In some embodiments, the at least one polymer binder included in the anode material makes up from about 10 wt. % to about 40 wt. % of the anode material. As noted previously, PAN is used as a polymer binder to form elastic and robust films to allow for controlled fragmentation/pulverization of silicon composite particles within the binder matrix. However, the role of cyclized PAN binder is different for Si-composite materials, given the particle level facture is not a concern. Cyclized PAN binder acts as a conductive matrix to provide pathways for electrons and also helps form an SEI layer in an organic solvent, such as carbonate-based, electrolyte compositions. The prior art teaches the use of ionic liquid-based electrolytes to enable cyclized PAN binder and pure metallic silicon material. However, the use of organic solvent-based electrolytes were shown to degrade battery performance. In contrast, the present disclosure reports the use of Si-composite material, conductive carbon and cyclized PAN polymer binder without ionic liquid-based electrolyte compositions.

In some embodiments wherein PAN is used as some or all of the polymer binder component of the anode material, the anode material is prepared and/or treated in such a way that the PAN becomes cyclized PAN. That is to say, in the final form of the anode material, the polymer binder includes cyclized PAN. Any method of preparing and/or treating the anode material in order to cyclize the PAN may be used. In some embodiments, the anode material is heated within a range of from about 200° C. to about 600° C. in order to cyclize the PAN polymer binder component. In some embodiments, the anode material is heated to a temperature above 230° C. to carrying out this cyclization. In some embodiments, a temperature range of between 240° C. and 400° C. is used.

The anode material formulation described herein includes a plurality of conductive carbon particles, such as conductive carbon nanoparticles. When conductive carbon particles are included in the anode material, they may be present in a range of from about 0.1 wt. % to about 5 wt. %. Any suitable conductive nanoparticles can be used, including, but not limited to, vapor grown carbon fibers (VGCF), carbon black, and carbon nanotubes. Such conductive nanoparticles can enhance the conductivity of the anode material.

In addition to the previously described Si-composite particles, conductive carbon particles and polymer binder, the anode material described herein may include other materials typically suitable for use in an anode material. For example, and as described previously, non-Si-composite particles may also be included in the anode material. Other materials that may be present in the anode material include, but are not limited to, sulfur, hard-carbon, graphite, tin, and germanium particles. When present in the anode material, these additional materials may be present in a range of from about 0.1 wt. % to about 60 wt. % of the anode composite material, such as in a range of from about 10 wt. % to about 60 wt. %.

Other additional components that may be included in the anode material include acid binders. Acid binders that may be included in the anode slurry used to make the anode material can include, for example, oxalic acid, citric acid, maleic acid, tartaric acid, and 1,2,3,4-butanetetracarboxylic acid. Acid binders can be used to improve dispersion and adhesion properties. When used in the anode material, the acid binder may be present in the anode formulation a range from about 0.01 wt. % to about 2 wt. %.

The anode including Si-composite materials described herein can be incorporated into an electrochemical energy storage device. The electrochemical energy storage device includes the anode as described herein, a cathode, and an electrolyte. In some embodiments, the electrochemical energy storage device is a lithium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical energy storage device is an electrochemical cell, such as a capacitor. In some embodiments, the capacitor is an asymmetric capacitor or supercapacitor. In some embodiments, the electrochemical cell is a primary cell. In some embodiments, the primary cell is a lithium/MnO₂ battery or Li/poly(carbon monofluoride) battery.

Suitable cathodes for use in the electrochemical energy storage device include those such as, but not limited to, a lithium metal oxide, spinel, olivine, carbon-coated olivine, LiCoO₂, LiNiO₂, LiMn_{0.5}Ni_{0.5}O₂, LiMn_{0.3}Co_{0.3}Ni_{0.3}O₂, LiMn₂O₄, LiFeO₂, LiNiₓCo_{y}Met_{z}O₂, AnB₂(XO₄)₃, vanadium oxide, lithium peroxide, sulfur, polysulfide, a lithium carbon monofluoride (also known as LiCFₓ) or mixtures of any two or more thereof, where Met is Al, Mg, Ti, B, Ga, Si, Mn or Co; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, and 0≤z≤0.5 and 0≤n′≤0.3. According to some embodiments, the spinel is a spinel manganese oxide with the formula of Li₁₊ₓMn_{2-z}Met′″_{y}O₄₋ₘX′ₙ, wherein Met′″ is Al, Mg, Ti, B, Ga, Si, Ni or Co; X′ is S or F; and wherein 0≤x≤0.3, 0≤y≤0.5, 0≤z≤0.5, 0≤m≤0.5 and 0≤n≤0.5. In other embodiments, the olivine has a formula of LiFePO₄, or Li₁₊ₓFe_{1z}Met″_{y}PO₄₋ₘX′ₙ, wherein Met″ is Al, Mg, Ti, B, Ga, Si, Ni, Mn or Co; X′ is S or F; and wherein 0≤x≤0.3, 0 0≤y≤0.5, 0≤z≤0.5, 0≤m≤0.5 and 0≤n≤0.5.

In some embodiments, the electrolyte component of the electrochemical energy storage device includes an aprotic organic solvent system, a metal salt, and at least one electrolyte additive.

In some embodiments, the aprotic organic solvent component of the electrolyte is selected from open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof in a range of from 20 wt. % to 90 wt. %.

In some embodiments, the metal salt component of the electrolytes is a lithium salt in a range of from 10 wt. % to 30 wt. %. A variety of lithium salts may be used, including, for example, Li(AsF₆); Li(PF₆); Li(CF₃CO₂); Li(C₂F₅CO₂); Li(CF₃SO₃); Li[N(CP₃SO₂)₂]; Li[C(CF₃SO₂)₃]; Li[N(SO₂C₂F₅)₂]; Li(ClO₄); Li(BF₄); Li(PO₂F₂); Li[PF₂(C₂O₄)₂]; Li[PF₄C₂O₄]; lithium alkyl fluorophosphates; Li[B(C₂O₄)₂]; Li[BF₂C₂O₄]; Li₂[B₁₂Z₁₂₋ⱼHⱼ]; Li₂[B₁₀X₁₀₋ⱼ·Hⱼ·]; or a mixture of any two or more thereof, wherein Z is independent at each occurrence a halogen, j is an integer from 0 to 12 and j′ is an integer from 1 to 10.

In some embodiments, the electrolyte additive is a compound containing at least one unsaturated carbon-carbon bond, carboxylic acid anhydrides, sulfur-containing compounds, phosphorus-containing compounds, boron-containing compounds, silicon-containing compounds, or mixtures thereof in a range of from 0.1 wt. % to 10 wt. %.

In some embodiments where the electrochemical energy storage device is a secondary battery, the secondary battery may further include a separator separating the positive and negative electrode. The separator for the lithium battery often is a microporous polymer film. Examples of polymers for forming films include polypropylene, polyethylene, nylon, cellulose, nitrocellulose, polysulfone, polyacrylonitrile, polyvinylidene fluoride, polybutene, or copolymers or blends of any two or more such polymers. In some instances, the separator is an electron beam-treated micro-porous polyolefin separator. The electron treatment can increase the deformation temperature of the separator and can accordingly enhance thermal stability at high temperatures. Additionally, or alternatively, the separator can be a shut-down separator. The shut-down separator can have a trigger temperature above about 130° C. to permit the electrochemical cells to operate at temperatures up to about 130° C.

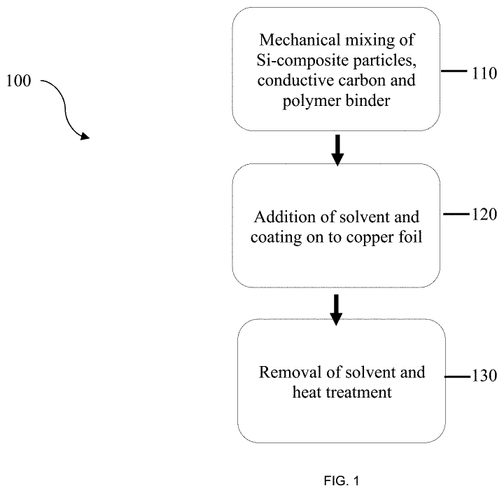

With reference to FIG. 1, a flow diagram showing an embodiment of a method 100 for preparing the anode material described herein includes step 110 of mixing together silicon composite particles, conductive carbon particles and a polymer binder to form a mixture, a step 120 of adding a solvent to the mixture and coating the mixture on a copper current collector, and a step 130 of removing the solvent form the coating and subjecting the coated current collector to a heat treatment.

With respect to step 110, silicon composite particles, conductive carbon particles and at least on polymer binder are mixed together to form a mixture. Any manner of mixing together these materials can be used, though in some embodiments, mechanical mixing is used. For example, the components can be mixed together by ball milling the solids at low rpm.

In step 120, a solvent is added to the mixture to disperse the active material particles. Any suitable solvent can be used at any suitable amount. In some embodiments, the solvent is anhydrous NMP. Other suitable solvents include, but are not limited to, N,N-dimethylformamide (DMF), dimethyl sulfone (DMSO₂), dimethyl sulfoxide (DMSO), ethylene carbonate (EC), and propylene carbonate (PC). The solvent can be mixed with the mixture of silicon composite particles, conductive carbon particles and polymer binder for any suitable amount of time, such as around 12 hours. Solvent mixing can be done using high shear centrifugal mixing or using a stir-bar in a glass vial.

Step 120 further includes coating the slurry mixture on a current collector. The material of the current collector can be any suitable current collector material, such as copper. The coating step can be carried out using any suitable techniques and equipment, such as a benchtop doctor-blade coater.

In step 130, the solvent is removed from the material coated on the current collector and then the coated current collector is subjected to a heat treatment. While this step is described as two separate actions, it may be possible in some embodiments to remove the solvent from the coating as part of the heat treatment step. When solvent is removed first, the solvent can be removed by heating the coating at a temperature generally below the temperature used in the subsequent heat treatment step but above the temperature needed to remove the solvent from the coating. For example, in some embodiments, the solvent is removed from the coating by first subjecting the coated current collector to a temperature of about 60° C. (such as in a convection oven) to evaporate off the solvent.

Following solvent removal, step 130 continues with the coated current collector being subjected to a heat treatment. The heat treatment may include heating the coated current collector in an inert atmosphere to a temperature in the range of from about 200° C. to about 600° C., such as in an inert argon gas atmosphere at about 330° C. The temperature can be in the range of from about 240° C. to about 400° C. The heat treatment step is generally aimed at cyclizing the polymer component of the coating. As described previously, the polymer component of the coating may be PAN. Cyclization of PAN is the process when the nitrile bond (CHEN) gets converted to a double bond (C═N) due to crosslinking of PAN molecules. This process yields ladder polymer chains of PAN fiber that are elastic but mechanically robust, thus allowing for controlled fragmentation of silicon particles.

The disclosure will be further illustrated with reference to the following specific examples. It is understood that these examples are given by way of illustration and are not meant to limit the disclosure or the claims to follow.

### Examples

Silicon oxide composite material was mixed with conductive carbon black and 150,0001 MW (150K) PAN for the anodes of Examples 1 and 2 and mixed with conductive carbon black and PVDF for the Comparative Example anode by ball milling the solids at low rpm. Anode compositions are shown in Table 1 below. Anhydrous NMP was used as solvent to disperse the C65 conductive carbon black additive using centrifugal mixing before adding the silicon/PAN solid mixture to the dispersion for Examples 1 and 2 and before adding the silicon/PVDF solid mixture for the Comparative Example. The respective slurries were mixed overnight, and a benchtop doctor-blade coater was used to coat the slurries onto copper current collectors to obtain anode electrodes with >3 mg/cm′ solid loadings. The anode electrodes were dried at 60° C. to remove NMP solvent.

Except for the Comparative anode electrode that contains PVDF binder, the two anode electrodes of Examples 1 and 2 containing PAN binder were then heat treated in an inert argon atmosphere at 330° C. During the heat treatment process PAN binder undergoes a cyclization process to convert the suspended nitrile (triple bonds) to conjugated nitrile groups.

TABLE 1
Comparison of Anode compositions

| Material weight (%) | Comparative | Example 1 | Example 2 |
|---|---|---|---|
| Silicon oxide | 87.75 | 87.75 | 78 |
| Binder | 9.75 (PVDF) | 9.75 (PAN) | 19.5 (PAN) |
| Conductive carbon | 2.5 | 2.5 | 2.5 |

To understand the effectiveness of the cyclized PAN binder in providing both mechanical integrity and conductivity, full pouch cells were tested against NMC 811 cathode (4 mAh/cm²). Table 2 compares the full cell data for anode compositions shown in Table 1. An organic solvents-based electrolyte was used for all anode compositions listed in Table 1.

Table 2 provides the composition of the organic solvents-based electrolyte

| Material | Weight % |
|---|---|
| Ethylene carbonate (EC) | 16.6 |
| Fluoro-ethylene carbonate (FEC) | 8.3 |
| Diethyl carbonate (DEC) | 14.5 |
| Ethyl methyl carbonate (EMC) | 14.5 |
| Propyl propionate (PP) | 29.1 |
| LiPF₆ (salt) | 13 |
| Vinyl carbonate (VC) | 1 |
| LiPO₂F₂ | 1 |
| Propane Sultone (PaS) | 1 |

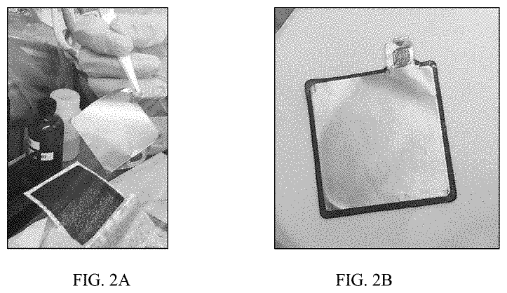

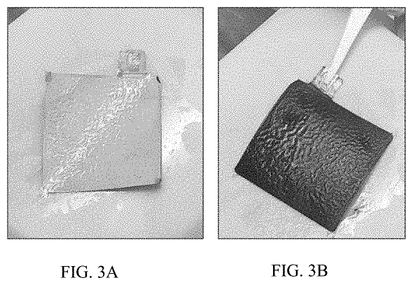

FIGS. 2 and 3 show the mechanical integrity of anode electrode after completion lithiation. Clearly cyclized PAN binder provides strong mechanical strength compared to known binder systems.

Table 3 compares measured electrochemical properties of the anode electrodes against NMC811 cathode. Cyclized PAN binder provides higher lithiation capacity. Whereas the PVDF binder performed poorly due to conductive nature and poor mechanical strength.

TABLE 3
Full cell data

| Parameter | Comparative | Example 2 |
|---|---|---|
| Delivered capacity (mAh/cm²) | 3.82 | 0.67 |
| Delivered anode capacity (mAh/g) | 1370 | 313 |
| First cycle efficiency (%) | 78.4 | 21.1 |
| AC impedance (m Ω) | 326 | 41 |

Accordingly, via a roll-to-roll anode coating process, we can engineer the surface chemistry of silicon materials. Cyclized PAN polymer binder driven coating imparts its mechanical strength, electrical conductivity, and chemical stability to Silicon, addressing the major challenges.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

I/We claim:

1. An anode formulation for forming an anode for use in an electrochemical energy storage device, the anode formulation comprising:
a plurality of active Si-composite material particles;
a plurality of conductive carbon particles; and
at least one polymer binder that undergoes a cyclization reaction when heated.

2. The anode formulation of claim 1, wherein the Si-composite material is a Si-carbon composite material.

3. The anode formulation of claim 1, wherein the Si-composite material is a silicon oxide material.

4. The anode formulation of claim 1, wherein the plurality of Si-composite material particles comprises particles in a range of from about 1 nm to about 100 μm.

5. The anode formulation of claim 1, wherein the at least one polymer binder comprises polyacrylonitrile.

6. The anode formulation of claim 1, wherein the plurality of Si-composite particles comprises from about 10% to about 90% by weight of the anode formulation.

7. The anode formulation of claim 1, wherein the plurality of conductive carbon particles comprises from about 0.1 wt. % to about 5 wt. % of the anode formulation.

8. The anode formulation of claim 1, wherein the at least one polymer binder comprises from about 10% to about 40% by weight of the anode formulation.

9. The anode formulation of claim 1, wherein the conductive carbon particles comprise nanoparticles of vapor grown carbon fibers (VGCF), carbon black, carbon nanotubes or mixture thereof.

10. The anode formulation of claim 1, further comprising an acid binder comprising from about 0.01 wt. % to about 2 wt. % of the anode formulation.

11. The anode formulation of claim 10, wherein the acid binder comprises oxalic acid, citric acid, maleic acid, tartaric acid, 1,2,3,4-butanetetracarboxylic acid or mixture thereof.

12. An anode for use in an electrochemical energy storage device, the anode comprising:
a current collector having a coating comprising an active Si-composite material, conductive carbon, and at least one cyclized polymer binder.

13. The anode of claim 12, wherein the at least one cyclized polymer binder is cyclized polyacrylonitrile.

14. The anode of claim 12, wherein the Si-composite material is a Si-carbon composite material.

15. The anode of claim 12, wherein the Si-composite material is a silicon oxide material.

16. The anode of claim 12, wherein the conductive carbon comprises vapor grown carbon fibers (VGCF), carbon black, carbon nanotubes or mixture thereof.

17. The anode of claim 12, further comprising an acid binder.

18. An electrochemical energy storage device comprising:
an anode comprising a current collector having a coating comprising active Si-composite material, conductive carbon, and at least one cyclized polymer binder;
a cathode; and
an electrolyte comprising fluorinated carbonate.

19. The electrochemical energy storage device of claim 18, wherein the Si-composite material is a Si-carbon composite material.

20. The electrochemical energy storage device of claim 18, wherein the Si-composite material is a silicon oxide material.

21. The electrochemical energy storage device of claim 18, wherein the at least one cyclized polymer binder comprises cyclized polyacrylonitrile.

22. The electrochemical energy storage device of claim 18, wherein the cathode further comprises a lithium metal oxide, spinel, olivine, carbon-coated olivine, vanadium oxide, lithium peroxide, sulfur, polysulfide, lithium carbon monofluoride or mixture thereof.

23. The electrochemical energy storage device of claim 18, wherein the cathode further comprises a transition metal oxide material and an over-lithiated oxide material.

24. The electrochemical energy storage device of claim 18, further comprising a porous separator separating the anode and the cathode from each other.

25. A method of making an anode for use in an electrochemical energy storage device, the method comprising:
a) mixing together active Si-composite particles, conductive carbon particles and at least one polymer binder that undergoes a cyclization reaction when heated, to form a mixture;
b) coating the mixture onto a current collector to form a coated current collector; and
c) subjecting the coated current collector to a temperature treatment cyclizing the at least one polymer binder.

26. The method of claim 25, wherein subjecting the coated current collector to the temperature treatment comprises heating the coated current collector in an inert atmosphere to a temperature in a range of from about 200° C. to about 600° C.

27. The method of claim 26, wherein the coated current collector is heated to a temperature in a range of from about 240° C. to about 400° C.

28. The method of claim 25, further comprising:
after step a) and before step b), adding a solvent to the mixture to disperse the Si-composite particles, conductive carbon particles and at least one polymer binder, wherein the solvent is selected from the group consisting of N-methyl-2-pyrrolidone (NMP), N,N-dimethylformamide (DMF), dimethyl sulfone (DMSO₂), dimethyl sulfoxide (DMSO), ethylene carbonate (EC), and propylene carbonate (PC).

29. The method of claim 28, further comprising:
after step b) and prior to step c), removing the solvent from the mixture coated on the current collector.

30. The method of claim 28, wherein step c) removes the solvent from the mixture coated on the current collector.

31. The method of claim 25, wherein the size of the Si-composite particles ranges from about 1 nm to about 100 μm.

32. The method of claim 25, wherein the mixture formed in step a) comprises from about 10% to about 90% by weight Si-composite particles.

33. The method of claim 25, wherein the mixture formed in step a) comprises from about 10% to about 40% by weight of the at least one polymer binder.

34. The method of claim 25, wherein the mixture formed in step a) comprises from about 0.1% to about 5% by weight of the conductive carbon particles.

35. The method of claim 25, wherein the at least one polymer binder is polyacrylonitrile.
